(19) United States
(12) Patent Application Publication
(10) Pub. No.: US 2026/0011024 A1
(43) Pub. Date: Jan. 8, 2026

(54) ROAD WATERLOGGING DEPTH MEASUREMENT METHOD BASED ON CONTOUR LINES GENERATED FROM POINT CLOUDS

(71) Applicant: CHINA THREE GORGES UNIVERSITY, Yichang (CN)

(72) Inventors: Yong Liu, Yichang (CN); Yuan Xu, Yichang (CN)

(21) Appl. No.: 19/316,976

(22) Filed: Sep. 2, 2025

(30) Foreign Application Priority Data
Jul. 2, 2024 (CN) 202410878481.X

(51) Int. Cl. G06T 7/564; G06T 7/13; G06T 7/521; G06V 10/75; G06V 10/764; G06V 20/10

(52) U.S. Cl. CPC G06T 7/564; G06T 7/13; G06T 7/521; G06V 10/752; G06V 10/764; G06V 20/176; G06T 2207/10028; G06T 2207/30168; G06T 2207/30181; G06T 2207/30244

(57) ABSTRACT

A road waterlogging depth measurement method based on contour lines generated from point clouds includes the steps of: S1, acquiring road surface point cloud data using a laser scanner, and processing the acquired road surface point cloud data; S2, generating a relatively regular triangulation network using oracle transportation management (OTM) software based on the processed data, and constructing a digital elevation model (DEM); S3, drawing contour lines by integrating the DEM with Toggle Contours technology, and performing quality inspection and post-processing on the drawn contour lines; S4, performing projection transformation on a contour map; and S5, calculating a road waterlogging depth. According to the present disclosure, by adopting the above method, urban waterlogging risk management in urban management systems can be effectively addressed, and installation and maintenance costs can be saved.

### CROSS-REFERENCE TO RELATED APPLICATION

This application claims priority of Chinese Patent Application No. 202410878481.X, filed on Jul. 2, 2024, the entire contents of which are incorporated herein by reference.

### TECHNICAL FIELD

The present disclosure relates to the technical field of urban waterlogging monitoring and early warning, and in particular to a road waterlogging depth measurement method based on contour lines generated from point clouds.

### BACKGROUND

Monitoring urban road water accumulation is an effective measure for preventing urban waterlogging, making real-time measurement of road waterlogging depth a key research focus. Currently, aside from traditional manual monitoring techniques that are gradually being phased out, existing waterlogging depth identification technologies primarily rely on various sensors such as smart water gauges and ultrasonic devices for contact or non-contact monitoring, and image-or video-based monitoring techniques that depend on existing reference objects. Current sensor-based monitoring technologies require the deployment of a large number of sensors to cover the entire urban road system, resulting in persistently high costs. Image-based monitoring technologies rely on specific reference objects, such as vehicle wheels, posing challenges for universal applications in practical urban management systems.

To solve the above problems, the present disclosure provides a road waterlogging depth measurement method based on contour lines generated from point clouds, utilizing existing urban cameras to achieve waterlogging depth measurement.

### SUMMARY

An objective of the present disclosure is to provide a road waterlogging depth measurement method based on contour lines generated from point clouds, which can effectively address urban waterlogging risk management in urban management systems and save installation and maintenance costs.

To realize the above objective, the present disclosure provides a road waterlogging depth measurement method based on contour lines generated from point clouds, including the steps of:
S1, acquiring road surface point cloud data using a laser scanner, and processing the acquired road surface point cloud data;
S2, generating a relatively regular triangulation network using oracle transportation management (OTM) software based on the processed data, and constructing a digital elevation model (DEM);
S3, drawing contour lines by integrating the DEM with Toggle Contours technology, and performing quality inspection and post-processing on the drawn contour lines;
S4, performing projection transformation on a contour map; and
S5, calculating a road waterlogging depth.

Preferably, in S1, the processing the acquired road surface point cloud data specifically includes the steps of:
S11, classifying the road surface point cloud data using Terrasolid software; and
S12, performing thinning treatment on road surface points.

Preferably, in S11, the classifying the road surface point cloud data using Terrasolid software specifically includes the steps of:
S111, low point separation: classifying lower points among neighboring points by employing the basic principle of comparing elevation values between a point and all other points within a defined distance range; and categorizing a central point as a low point class when it is significantly lower than surrounding points;
S112, road surface point cloud data extraction: iteratively constructing surface triangulation network models to separate surface points, completing the adjustment based on an Iteration Angle parameter, and combining various parameters to obtain optimal values while employing filtering methods to enhance overall effectiveness; and
S113, interactive manual classification: employing semi-automatic or manual methods for classifying unfiltered or hollow road surface points based on the above steps, obtaining accurate and complete point cloud data, and making decisions by referencing digital orthophoto map (DOM) data as a primary criterion for validation.

Preferably, in S12, the performing thinning treatment on road surface points, to reduce density of the point cloud data while preserving key topographic features, specifically includes the steps of:
S121, performing non-selective thinning based on random sampling rule; and
S122, executing selective thinning by preserving key elements while removing non-essential components.

Preferably, in S3, the parameters, including sampling interval and contour interval, are adjusted to ensure compliance with the specifications of a scaled topographic map; the contour interval is determined based on surveying and mapping requirements; the quality of the generated contour lines directly influences the sampling interval; and through multiple parameter adjustments, contour data that closely aligns with the DEM is produced and delivered in a shape format.

Preferably, in S3, the quality inspection is conducted based on the following aspects:
S321, graphics: evaluating whether positional displacement, omissions, or intersections occur; and
S322, attributes: assessing the accuracy of elevation values.

Preferably, in S3, the post-processing is performed on the contour lines using EPS and ArcGIS software, specifically including: smoothing contour lines, filtering and removing fragmented lines, processing edge matching, converting two-dimensional (2D) line segments to three-dimensional (3D) line segments, converting file formats, and assigning attribute codes.

Preferably, in S4, during the projection transformation of the contour map, with a mounting position of a camera pole on the road surface as an origin O, a camera pitch angle as γ, and a vertical field of view of the camera as β, the following relationship holds:

$$γ = α + \frac{1}{2} β$$

where a camera height h, a photosensitive plate length l₁, and a focal length f are used for calculating distances from the origin O to two focal points B and D between the camera's vertical field of view and the road surface, as follows:

$${S}_{1} = h tan α , {S}_{2} = h tan ( α + β )$$

a projected length of the focal length in a horizontal direction is as follows:

$${f}^{′} = f sin γ$$

with the camera's mounting position as the origin O, a width of the photosensitive plate is l₂, and the projected focal length in the horizontal direction is f′; A, B, C, and D are four intersection points between the camera's field of view and the road surface; the distances from the intersection points B and D of the camera's field of view with the road surface to the origin O are denoted as S₁ and S₂, respectively; and using the properties of similar triangles, lengths of l_{AB} and l_{CD} are calculated as follows:

$${l}_{AB} = {l}_{2} \frac{{S}_{1}}{{f}^{′}} , {l}_{CD} = {l}_{2} \frac{{S}_{2}}{{f}^{′}}$$

coordinates of A, B, C, and D are:

$$A ( - \frac{{l}_{2} {S}_{1}}{{f}^{′}} , h tan α ) , B ( \frac{{l}_{2} {S}_{1}}{{f}^{′}} , h tan α )$$

$$C ( - \frac{{l}_{2} {S}_{2}}{2 {f}^{′}} , h tan ( α + β ) ) , D ( \frac{{l}_{2} {S}_{2}}{2 {f}^{′}} , h tan ( α + β ) )$$

using a perspective transformation method, a top-down contour map is transformed to align with a fixed camera's perspective, and a transformation formula is as follows:

$$[ \begin{matrix}{x}^{′} & {y}^{′} & {w}^{′}\end{matrix} ] = [ \begin{matrix}u & v & w\end{matrix} ] [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ]$$

the transformed coordinates x and y are:

$$x = {x}^{′} / {w}^{′} , y = {y}^{′} / {w}^{′}$$

after expansion, the expressions are as follows:

$$x = \frac{{x}^{′}}{{w}^{′}} = \frac{{a}_{11} u + {a}_{21} v + {a}_{31}}{{a}_{13} u + {a}_{23} v + {a}_{33}} , x = \frac{{y}^{′}}{{w}^{′}} = \frac{{a}_{12} u + {a}_{22} v + {a}_{32}}{{a}_{13} u + {a}_{23} v + {a}_{33}}$$

by substituting the coordinates of four vertices A′, B′, C′, and D′ of the obtained 2D contour map, the top-down contour map is transformed to align with the fixed camera's perspective.

Preferably, in S5, image data are overlaid with the contour map to match road waterlogging areas in the image with the contour map, the contour lines corresponding to edges of the road waterlogging areas are identified, and contour interpolation is performed within the waterlogging area to calculate the waterlogging depth.

Therefore, according to the present disclosure, adopting the above road waterlogging depth measurement method based on contour lines generated from point clouds can effectively address urban waterlogging risk management in urban management systems and save installation and maintenance costs.

The technical solutions of the present disclosure are further described below in combination with the embodiments and drawings.

### BRIEF DESCRIPTION OF THE DRAWINGS

FIG. 1 shows a flowchart of a road waterlogging depth measurement method based on contour lines generated from point clouds according to the present disclosure;

FIG. 2a shows a large volume of acquired dense point cloud data according to a process of generating contour lines from point cloud data;

FIG. 2b shows a reconstructed road surface according to the process of generating contour lines from point cloud data;

FIG. 2c shows a color-graded elevation representation according to the process of generating contour lines from point cloud data;

FIG. 2d shows contour lines derived from corresponding point cloud data according to the process of generating contour lines from point cloud data;

FIG. 3 shows a simplified side view of a fixed camera;

FIG. 4 shows a simplified top view of the fixed camera;

FIG. 5 shows a schematic diagram of a simplified perspective transformation for the fixed camera;

FIG. 6 shows a simplified schematic of overlay between a contour map and a road waterlogging area identified by the camera.

FIG. 7 shows a minimum bounding rectangle of the contour lines;

FIG. 8a shows a waterlogging image captured at a monitoring point according to a technical depth test; and

FIG. 8b shows an experimental result image according to the technical depth test.

### DETAILED DESCRIPTION

The technical solutions of the present disclosure are further described below in combination with the specific embodiments and drawings.

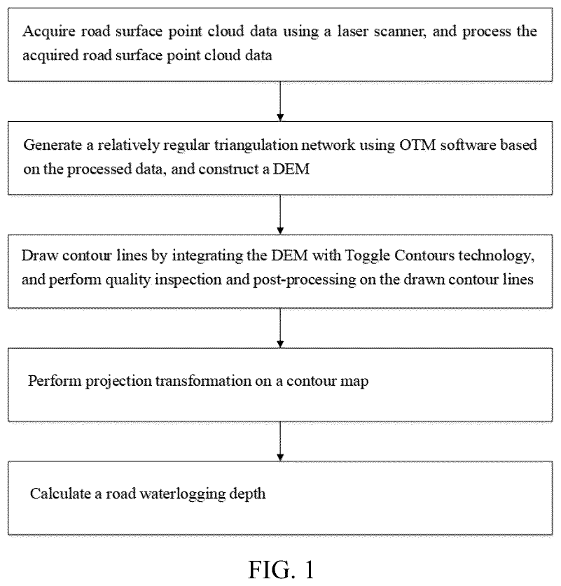

Referring to FIG. 1, a road waterlogging depth measurement method based on contour lines generated from point clouds includes the steps that:
In S1, road surface point cloud data are acquired using a laser scanner, and the acquired road surface point cloud data are processed.
In S2, a relatively regular triangulation network is generated using OTM software based on the processed data, and a DEM is constructed.
In S3, contour lines are drawn by integrating the DEM with Toggle Contours technology, and quality inspection and post-processing are performed on the drawn contour lines.
In S4, projection transformation is performed on a contour map.
In S5, a road waterlogging depth is calculated.

### Embodiment

In S1, road surface point cloud data are acquired using a laser scanner, and the acquired road surface point cloud data are processed.

Due to the high density and relatively disordered arrangement of light detection and ranging (LiDAR) point cloud data, classification processing of the data is required as a fundamental prerequisite before drawing contour lines, thereby extracting relevant data suitable for contour mapping. In recent years, as 3D LiDAR point cloud data processing technology has been widely adopted across various industries, related research efforts have also been extensively conducted. Currently, these primarily include the following four categories of point cloud classification algorithms: edge-based, region growing-based, model-based, and attributes-based algorithms.
In S11, the road surface point cloud data is classified using Terrasolid software, with specific steps outlined below:
In S111, low point separation: lower points are classified among neighboring points by employing the basic principle of comparing elevation values between a point and all other points within a defined distance range. When a central point is significantly lower than surrounding points, it is categorized as a low point class.
In S112, road surface point cloud data extraction: surface triangulation network models are iteratively constructed to separate surface points, and the adjustment is completed based on an Iteration Angle parameter. Various parameters are combined to obtain optimal values while filtering methods are employed to enhance overall effectiveness.
In S113, interactive manual classification: based on the above steps, semi-automatic or manual methods are employed for classifying unfiltered or hollow road surface points, thereby obtaining accurate and complete point cloud data. Decisions are made by referencing DOM data as a primary criterion for validation.
In S12, thinning treatment is performed on road surface points.

Although road surface points can be extracted through the classification-based method, the resulting data still belong to dense point clouds. At this time, the selection and generalization of topographic features need to be determined by a map scale to achieve an appropriate depiction of detailed terrain features for topographic mapping purposes. Therefore, the data need to be thinned here to ensure mapping requirements are met, thereby preventing issues such as surface irregularities caused by excessive road surface point clouds, which could ultimately compromise the overall cartographic quality of the topographic map.

Currently, the thinning process can be accomplished by combining two methods: first, non-selective thinning based on random sampling rule; second, selective thinning that preserves key elements while removing non-essential components. Through the above methods, the density of the point cloud data is reduced while preserving key topographic features.
In S2, a relatively regular triangulation network is generated using OTM software based on the processed data, and a DEM is constructed.
In S3, contour lines are drawn by integrating the DEM with Toggle Contours technology, and quality inspection and post-processing are performed on the drawn contour lines.
In S31, the parameters, such as sampling interval and contour interval, are adjusted to ensure compliance with the specifications of a scaled topographic map. The contour interval is determined based on surveying and mapping requirements, and the quality of the generated contour lines directly influences the sampling interval. Cartographic generalization becomes more extensive as the sampling interval increases, resulting in poorer alignment with the DEM but facilitating rapid contour generation. Conversely, when the sampling interval decreases, it aligns more closely with the DEM but slows down the final generation speed. Through multiple parameter adjustments, contour data that closely aligns with the DEM is produced and delivered in a shape format.
In S32, upon successful generation of contour lines that meet quality requirements, the subsequent inspection is conducted based on the following aspects:
In S321, graphics: it is evaluated whether positional displacement, omissions, or intersections occur.
In S322, attributes: the accuracy of elevation values is assessed.
In S33, after completing the quality inspection of the graphics, the post-processing is performed on the contour lines using software such as EPS and ArcGIS, specifically including: smoothing contour lines, filtering and deleting fragmented lines, handling edge-matching, converting 2D line segments to 3D line segments, converting file formats, and assigning attribute codes.

According to the shooting range of a fixed camera, road point cloud data are acquired using point cloud scanning equipment under dry conditions (without water accumulation), and a road contour map is generated using software such as EPS.

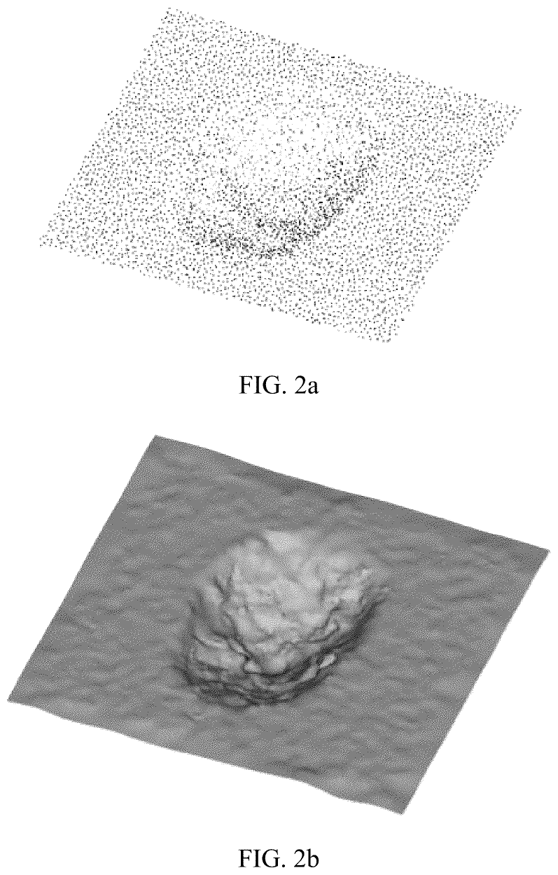

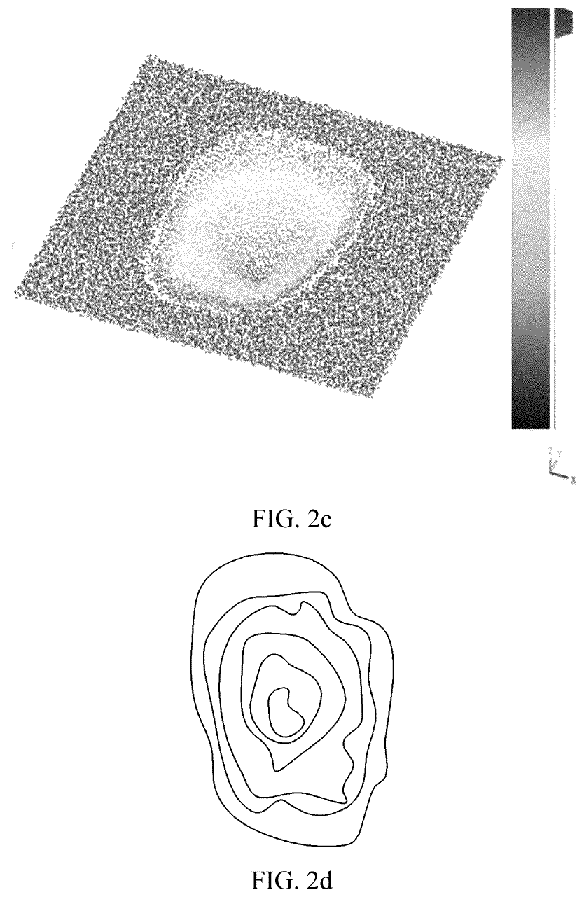

Using an unmanned aerial vehicle (UAV) mounted with a laser scanner, the road surface point cloud data, as captured by the fixed camera, are collected, with a depression in an urban road surface serving as an example. As shown in FIG. 2a, a large volume of dense point cloud data is acquired. Subsequently, surface reconstruction is performed on the scanned road surface, as shown in FIG. 2b. The point cloud is color-coded based on its elevation information, where different colors represent different elevation values. This step is critical for generating contour lines from the point cloud, as it extracts elevation information from the road surface point cloud data, facilitating the clear observation of undulations and variations in the road point cloud, as shown in FIG. 2c. Filtering is performed on the point cloud data to remove outliers from the point cloud data, and contour lines corresponding to the point cloud data are generated using EPS software, as shown in FIG. 2d.
In S4, projection transformation is performed on a contour map.

The contour lines drawn in FIG. 6 represent an orthographic projection from a vertically downward perspective, while a waterlogging area in the actual camera view is observed from a certain tilt angle. For comparison, the two representations need to be transformed into a unified coordinate system. For the fixed camera angled downward toward the road surface, it captures a rectangular image, which corresponds to an isosceles trapezoid area on the road.

According to the height and pitch angle of the fixed camera, along with parameters such as its focal length and photosensitive element size, a specific spatial coverage of the area captured by the fixed camera can be calculated. Based on this spatial coverage, a contour map corresponding to the image captured by the fixed camera can be cropped, facilitating the transformation of a top-down 2D contour map into a camera-perspective coordinate system, thereby allowing comparison with an image captured under waterlogged conditions. Specific steps are as follows:

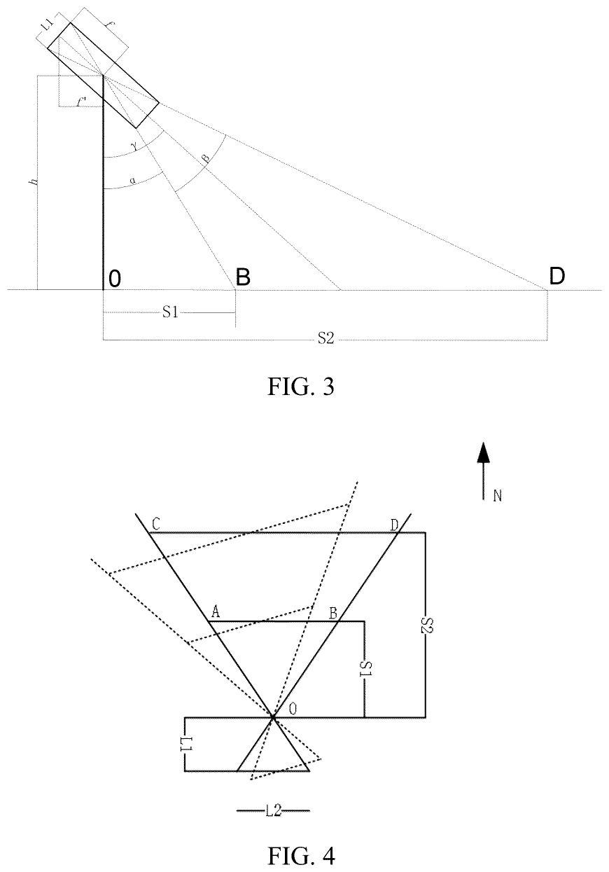

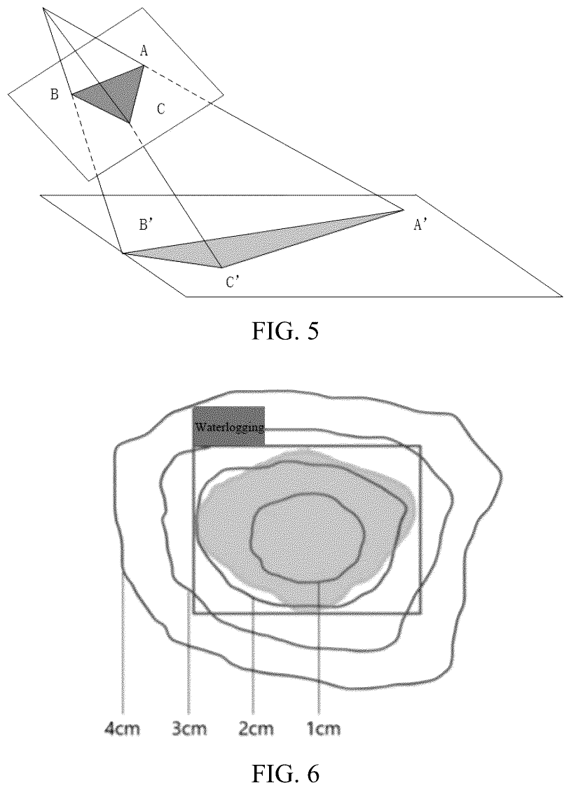

Referring to FIG. 3, with a mounting position of a camera pole on the road surface as an origin O, a camera pitch angle (camera angle) is denoted as γ, a vertical field of view of the camera is β, and an angle α is labeled as shown in FIG. 3, as follows:

$$γ = α + \frac{1}{2} β$$

where a camera height h, a photosensitive plate length l₁, and a focal length f are used for calculating distances from the origin O to two focal points B and D between the camera's vertical field of view and the road surface, as follows:

$${S}_{1} = h tan α , {S}_{2} = h tan ( α + β )$$

A projected length of the focal length in a horizontal direction is as follows:

$${f}^{′} = f sin γ$$

Referring to FIG. 4, with the camera's mounting position as the origin O, a width of the photosensitive plate is l₂, and the projected focal length in the horizontal direction is f′; A, B, C, and D are four intersection points between the camera's field of view and the road surface; the distances from the intersection points B and D of the camera's field of view with the road surface to the origin O are denoted as S₁ and S₂, respectively. Using the properties of similar triangles, lengths of l_{AB} and l_{CD} are calculated as follows:

$${l}_{AB} = {l}_{2} \frac{{S}_{1}}{{f}^{′}} , {l}_{CD} = {l}_{2} \frac{{S}_{2}}{{f}^{′}}$$

Coordinates of A, B, C, and D are:

$$A ( - \frac{{l}_{2} {S}_{1}}{{f}^{′}} , h tan α ) , B ( \frac{{l}_{2} {S}_{1}}{{f}^{′}} , h tan α )$$

$$C ( - \frac{{l}_{2} {S}_{2}}{2 {f}^{′}} , h tan ( α + β ) ) , D ( \frac{{l}_{2} {S}_{2}}{2 {f}^{′}} , h tan ( α + β ) )$$

Referring to FIG. 4, using a perspective transformation method, the top-down contour map is transformed to align with a fixed camera's perspective, and a transformation formula is as follows:

$$[ \begin{matrix}{x}^{′} & {y}^{′} & {w}^{′}\end{matrix} ] = [ \begin{matrix}u & v & w\end{matrix} ] [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ]$$

The transformed coordinates x and y are:

$$x = {x}^{′} / {w}^{′} , y = {y}^{′} / {w}^{′}$$

After expansion, the expressions are as follows:

$$x = \frac{{x}^{′}}{{w}^{′}} = \frac{{a}_{11} u + {a}_{21} v + {a}_{31}}{{a}_{13} u + {a}_{23} v + {a}_{33}} , y = \frac{{y}^{′}}{{w}^{′}} = \frac{{a}_{12} u + {a}_{22} v + {a}_{32}}{{a}_{13} u + {a}_{23} v + {a}_{33}}$$

By substituting the coordinates of four vertices A′, B′, C′, and D′ of the obtained 2D contour map, the top-down contour map is transformed to align with the fixed camera's perspective.

The laser scanner is used for acquiring the road surface point cloud data. After a series of processing of the road surface point cloud data, a road topographic contour map is ultimately generated. The projection transformation is performed on this topographic contour map to align it with the camera's perspective, in preparation for overlaying the waterlogged image captured by the fixed camera with a contour image.
In S5, a road waterlogging depth is calculated.

The image from a shooting system is overlaid with the contour map to match road waterlogging areas in the image with the contour map, the contour lines corresponding to edges of the road waterlogging areas are identified, and contour interpolation is performed within the waterlogging area to calculate the waterlogging depth.

Discrete points are set on the contour lines to obtain positional coordinates of each point. By identifying maximum and minimum values of x-coordinates and y-coordinates, which serve as vertex coordinates of a minimum bounding rectangle for the contour lines, an area Sᵢ of the contour's bounding rectangle can be calculated. The area Sᵢ of each contour's bounding rectangle is compared with an area S₀ of a bounding box of a waterlogging range to identify the best-matching contour range.

The waterlogging depth is calculated using the elevation difference between contour lines within the waterlogging range, as shown in FIG. 6, where purple curves represent contour lines, a blue region indicates the waterlogging range, and a red box denotes a waterlogging bounding box detected by an image recognition algorithm. The waterlogging bounding box matches the 2 cm contour line and exceeds its elevation. To further improve computational accuracy, the interval between the 2 cm and 3 cm contour lines can be refined with a step size of 0.1 cm, followed by interpolation calculations.

Based on discrete data, a continuous function is interpolated into the dataset such that the resulting continuous curve passes through all given discrete data points. As a key method in discrete function approximation, based on interpolation using a finite number of sample points, it achieves the estimation of approximate waterlogging depths at other locations.

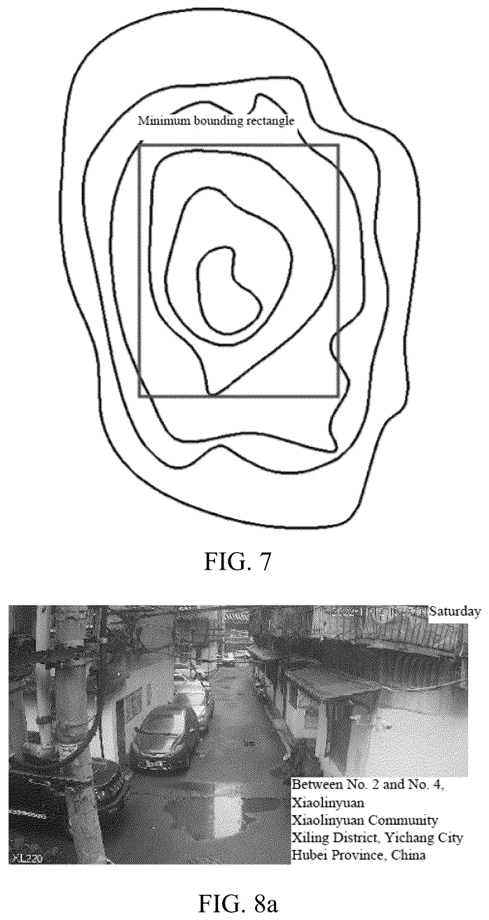

During polygon construction from the discrete points, adjacent discrete points are directly connected to form a curve-inscribed polygon, with the vertices being the discrete points themselves. This method is relatively simple to operate, but the resulting contour lines ultimately form within a closed curve (although the edges of concave polygons may lie outside this curve, the edges are often omitted during the calculation of the minimum bounding rectangle, thereby not significantly affecting a final result). Consequently, the minimum area of the resulting bounding rectangle is often smaller than the contour area. The above method compensates for deficiencies by integrating and defining a tolerance to enlarge the polygon. Specifically, a tolerance value is determined based on the number of discrete points on the curve. The edges of the shape are translated outward along normal directions, and the intersection points of the extended edges are taken as new vertices of the polygon, thereby achieving polygon enlargement, as shown in FIG. 7.

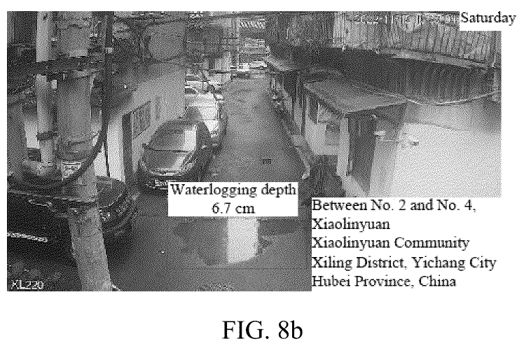

Two fixed cameras in an urban management system are used for capturing images at different times, with field measurements of waterlogging depth conducted simultaneously, as shown in FIG. 8. The waterlogging depth is calculated from image data and compared with the measured waterlogging depth. The measured camera extrinsic parameters (height and angle) and result analysis are presented in Table 1. The calculated camera extrinsic parameters, height in millimeters (mm), and angle in degrees (°), are derived, with testing errors remaining within acceptable tolerance thresholds. Based on the calculated camera extrinsic parameters, the waterlogging depths are calculated across different times under the same camera and compared with the measured waterlogging depths. The waterlogging depth is reported in centimeters (cm), with results detailed in Table 2. The calculation of waterlogging depth exhibits minimal deviation, ensuring high accuracy, and is suitable for real-time monitoring of road waterlogging depth.

TABLE 1
Camera height and angle calculations

| | | | | Height | | | | Angle |
|---|---|---|---|---|---|---|---|---|
| Serial | Measured | Calculated | Height | deviation | Measured | Calculated | Angle | deviation |
| number | height | height | deviation | rate | angle | angle | deviation | rate |
| 1 | 2950.0 | 2926.4 | −22.7 | −0.765% | 41.0 | 40.7 | −0.3 | −0.732% |
| 2 | 3550.0 | 3521.6 | −27.9 | −0.786% | 55.0 | 55.4 | 0.4 | 0.727% |

TABLE 2
Waterlogging depth calculation

| Serial | | Measured | Calculated | Deviation |
|---|---|---|---|---|
| number | Time | depth | depth | value |
| 1 | Time 1 | 4.2 | 4.3 | 0.1 |
| | Time 2 | 5.1 | 5.0 | −0.1 |
| | Time 3 | 7.8 | 7.7 | −0.1 |
| | Time 4 | 6.9 | 6.7 | −0.2 |
| 2 | Time 1 | 4.7 | 4.7 | 0 |
| | Time 2 | 3.9 | 3.8 | −0.1 |
| | Time 3 | 2.8 | 2.7 | −0.1 |
| | Time 4 | 2.1 | 2.2 | 0.1 |

Therefore, the present disclosure adopts the above road waterlogging depth measurement method based on contour lines generated from point clouds, effectively addressing urban waterlogging risk management in urban management systems and saving installation and maintenance costs.

Finally, it is to be noted that the above embodiments are only provided to illustrate the technical solutions of the present disclosure and do not constitute any limitations. Although the present disclosure has been described in detail with reference to the preferred embodiments, it is to be understood by those of ordinary skill in the art that modifications or equivalent replacements to the technical solutions of the present disclosure may still be made without departing from the spirit and scope of the technical solutions of the present disclosure.

1. A road waterlogging depth measurement method based on contour lines generated from point clouds, comprising the steps of:
S1, acquiring road surface point cloud data using a laser scanner, and processing the acquired road surface point cloud data;
S2, generating a relatively regular triangulation network using oracle transportation management (OTM) software based on the processed data, and constructing a digital elevation model (DEM);
S3, drawing contour lines by integrating the DEM with Toggle Contours technology, and performing quality inspection and post-processing on the drawn contour lines;
S4, performing projection transformation on a contour map; and
S5, calculating a road waterlogging depth.

2. The road waterlogging depth measurement method based on contour lines generated from point clouds according to claim 1, wherein in S1, the processing the acquired road surface point cloud data specifically comprises the steps of:
S11, classifying the road surface point cloud data using Terrasolid software; and
S12, performing thinning treatment on road surface points.

3. The road waterlogging depth measurement method based on contour lines generated from point clouds according to claim 2, wherein in S11, the classifying the road surface point cloud data using Terrasolid software specifically comprises the steps of:
S111, low point separation: classifying lower points among neighboring points by employing the basic principle of comparing elevation values between a point and all other points within a defined distance range; and categorizing a central point as a low point class when it is significantly lower than surrounding points;
S112, road surface point cloud data extraction: iteratively constructing surface triangulation network models to separate surface points, completing adjustment based on an Iteration Angle parameter, and combining various parameters to obtain optimal values while employing filtering methods to enhance overall effectiveness; and
S113, interactive manual classification: employing semi-automatic or manual methods for classifying unfiltered or hollow road surface points based on the above steps, obtaining accurate and complete point cloud data, and making decisions by referencing digital orthophoto map (DOM) data as a primary criterion for validation.

4. The road waterlogging depth measurement method based on contour lines generated from point clouds according to claim 2, wherein in S12, the performing thinning treatment on road surface points, to reduce density of the point cloud data while preserving key topographic features, specifically comprises the steps of:
S121, performing non-selective thinning based on random sampling rule; and
S122, executing selective thinning by preserving key elements while removing non-essential components.

5. The road waterlogging depth measurement method based on contour lines generated from point clouds according to claim 1, wherein in S3, the parameters, comprising sampling interval and contour interval, are adjusted to ensure compliance with specifications of a scaled topographic map; the contour interval is determined based on surveying and mapping requirements; the quality of the generated contour lines directly influences the sampling interval; and through multiple parameter adjustments, contour data that closely aligns with the DEM is produced and delivered in a shape format.

6. The road waterlogging depth measurement method based on contour lines generated from point clouds according to claim 1, wherein in S3, the quality inspection is conducted based on the following aspects:
S321, graphics: evaluating whether positional displacement, omissions, or intersections occur; and
S322, attributes: assessing the accuracy of elevation values.

7. The road waterlogging depth measurement method based on contour lines generated from point clouds according to claim 1, wherein in S3, the post-processing is performed on the contour lines using EPS and ArcGIS software, specifically comprising: smoothing contour lines, filtering and removing fragmented lines, processing edge matching, converting two-dimensional (2D) line segments to three-dimensional (3D) line segments, converting file formats, and assigning attribute codes.

8. The road waterlogging depth measurement method based on contour lines generated from point clouds according to claim 1, wherein in S4, during the projection transformation of the contour map, with a mounting position of a camera pole on the road surface as an origin O, a camera pitch angle as γ, and a vertical field of view of the camera as β, the following relationship holds:
$$γ = α + \frac{1}{2} β$$
where a camera height h, a photosensitive plate length l₁, and a focal length f are used for calculating distances from the origin O to two focal points B and D between the camera's vertical field of view and the road surface, as follows:
$${S}_{1} = h tan α , {S}_{2} = h tan ( α + β )$$
a projected length of the focal length in a horizontal direction is as follows:
$${f}^{′} = f sin γ$$
with the camera's mounting position as the origin O, a width of the photosensitive plate is l₂, and the projected focal length in the horizontal direction is f′; A, B, C, and D are four intersection points between the camera's field of view and the road surface; the distances from the intersection points B and D of the camera's field of view with the road surface to the origin O are denoted as S₁ and S₂, respectively; and using the properties of similar triangles, lengths of l_{AB} and l_{CD} are calculated as follows:
$${l}_{AB} = {l}_{2} \frac{{S}_{1}}{{f}^{′}} , {l}_{CD} = {l}_{2} \frac{{S}_{2}}{{f}^{′}}$$
coordinates of A, B, C, and D are:
$$A ( - \frac{{l}_{2} {S}_{1}}{{f}^{′}} , h tan α ) , B ( \frac{{l}_{2} {S}_{1}}{{f}^{′}} , h tan α )$$
$$C ( - \frac{{l}_{2} {S}_{2}}{2 {f}^{′}} , h tan ( α + β ) ) , D ( \frac{{l}_{2} {S}_{2}}{2 {f}^{′}} , h tan ( α + β ) )$$
using a perspective transformation method, a top-down contour map is transformed to align with a fixed camera's perspective, and a transformation formula is as follows:
$$[ \begin{matrix}{x}^{′} & {y}^{′} & {w}^{′}\end{matrix} ] = [ \begin{matrix}u & v & w\end{matrix} ] [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ]$$
the transformed coordinates x and y are:
$$x = {x}^{′} / {w}^{′} , y = {y}^{′} / {w}^{′}$$
after expansion, the expressions are as follows:
$$x = \frac{{x}^{′}}{{w}^{′}} = \frac{{a}_{11} u + {a}_{21} v + {a}_{31}}{{a}_{13} u + {a}_{23} v + {a}_{33}} , y = \frac{{y}^{′}}{{w}^{′}} = \frac{{a}_{12} u + {a}_{22} v + {a}_{32}}{{a}_{13} u + {a}_{23} v + {a}_{33}}$$
by substituting the coordinates of four vertices A′, B′, C′, and D′ of the obtained 2D contour map, the top-down contour map is transformed to align with the fixed camera's perspective.

9. The road waterlogging depth measurement method based on contour lines generated from point clouds according to claim 1, wherein in S5, image data are overlaid with the contour map to match road waterlogging areas in the image with the contour map, the contour lines corresponding to edges of the road waterlogging areas are identified, and contour interpolation is performed within the waterlogging area to calculate the waterlogging depth.
